(19) United States
(12) Patent Application Publication
(10) Pub. No.: US 2026/0313300 A1
(43) Pub. Date: Oct. 8, 2026

(54) AUDIO PROCESSING USING HEARING LOSS DATA

(71) Applicants: Dolby Laboratories Licensing Corporation, San Francisco, CA (US); DOLBY INTERNATIONAL AB, Dublin (IE)

(72) Inventors: Panji SETIAWAN, Munich (DE); Dirk Jeroen BREEBAART, North Sydney (AU)

(73) Assignees: Dolby Laboratories Licensing Corporation, San Francisco, CA (US); DOLBY INTERNATIONAL AB, Dublin (IE)

(21) Appl. No.: 19/484,406

(22) PCT Filed: May 15, 2024
(86) PCT No.: PCT/US2024/029448

§ 371 Date: Nov. 14, 2025

Related U.S. Application Data
(60) Provisional application No. 63/502,391, filed on May 15, 2023.
(60) Provisional application No. 63/588,909, filed on Oct. 9, 2023.

(51) Int. Cl. H04R 25/00; G10K 11/175

(52) U.S. Cl. CPC H04R 25/505; G10K 11/1752; H04R 2430/01

(57) ABSTRACT

A method of processing audio, comprising receiving audio data for playback on a playback device, the audio data including target audio components, receiving masking audio data, obtaining hearing loss data associated with the listener, obtaining playback level data, calculating a target excitation pattern based on the target audio components and the playback level data, calculating a masking excitation pattern based on the masking audio data, calculating a signal gain based on the target excitation pattern, the masking excitation pattern, and the hearing loss data, and applying the signal gain to the target audio components to produce compensated target audio components.

### CROSS-REFERENCE TO RELATED APPLICATIONS

This application claims priority to U.S. Provisional Application 63/502,391 filed on May 15, 2023, and U.S. Provisional Application 63/588,909 filed on Oct. 9, 2023, the contents of which are herein incorporated by reference in their entirety.

### TECHNICAL FIELD

The present disclosure relates generally to signal processing, and more specifically to techniques, devices, and computer-executable instructions for processing signals related to multimedia content. Specifically, the disclosure relates to compensation of hearing impairment.

### BACKGROUND

Recent statistics indicate that approximately 15% of American adults report some trouble hearing, with age being the strongest predictor of hearing loss. Men are almost twice as likely as women to have hearing loss. About 2% of the adult population aged 45 to 54 have disabling hearing loss, increasing to 8.5 and 25% for age brackets 55-64, and 65-74%. In addition, it is estimated that about 28 million US adults could benefit from using hearing aids.

To provide solutions for people with hearing loss, the hearing aid industry has been developing hearing-aids and associated fitting rules for decades. The goal of these fitting rules is to describe a hearing optimization algorithm (or hearing aid) in terms of what gain needs to be applied at what frequency for signals captured by microphones on the hearing aids and reproduced to the listener. In the early days, around 1950, the half-gain rule was a popular approach to determine a frequency-dependent gain. In the absence of dynamic range processing capabilities, the idea was to apply a gain that corresponds to half the hearing loss in decibels (dB). Hence this fitting rule offered a single gain target for any particular type of hearing loss that is the same for all input levels.

In the 90s, compression-based fitting rule emerged, with popular of these being DSL (Desired Sensation Level) and NAL-NL1 (National Acoustics Labs, Non-Linear, version 1). The philosophy behind the NAL fitting rules is that they try to equalize, rather than normalize, loudness relationships across speech frequencies. In particular, the assumption is that if all frequencies of speech are amplified such that they are heard equally loud, speech intelligibility is assumed to be maximized. In other words, the NAL methods do not preserve the loudness relationship between speech frequencies; instead, they aim at maximizing the information provided to the listener with respect to speech, given a specific amount of hearing loss. In NAL terms, this is described as maximizing ‘effective audibility’ instead of ‘audibility’ per se, or sensation level.

### BRIEF SUMMARY

Our perception of loudness, timbre, spectral naturalness, externalization of spatial audio and speech intelligibility depends on a variety of contextual factors, such as the amount hearing loss, auditory masking by media components (such as music and effects), the media playback level, and environmental sounds like background noise. These factors are not simply additive, but instead interact in complex ways. Preservation of media artistic intent, naturalness, envelopment, immersion, realism and speech intelligibility of media reproduced over hearables (e.g., headphones, earbuds, hearing aids, etc.) can greatly benefit from an algorithm that optimizes for the combined negative effects of hearing loss, the impact of playback level, and the amount of masking from other media components and the environmental sounds. This has relevance for content types beyond speech, including traditional linear media content such as music, movies, but also for non-linearly produced or interactive media content such as AR, VR, and gaming.

Described herein are techniques that provide for preservation of media artistic intent (e.g., loudness, timbre, spectral naturalness, externalization of spatial audio and speech intelligibility, envelopment, immersion, realism, etc.) of media reproduced with playback devices (e.g., headphones, earbuds, hearing aids, AR/VR devices, head-mounted displays, etc.) for individuals with hearing impairment. The described techniques are compatible with devices and systems supporting MPEG-I.

A first aspect relates to method of processing audio for a listener of a playback device, comprising receiving audio data for playback on the playback device, the audio data including target audio components, receiving masking audio data, obtaining hearing loss data associated with the listener, obtaining playback level data, calculating a target excitation pattern based on the target audio components and the playback level data, calculating a masking excitation pattern based on the masking audio data, calculating a signal gain based on the target excitation pattern, the masking excitation pattern, and the hearing loss data, and applying the signal gain to the target audio components to produce compensated target audio components.

The playback level data describes the (frequency dependent) conversion of a digital input signal to sound pressure levels reaching the ears of the listener. The playback level data may be actual playback level data received e.g., from the playback device. Alternatively, it may be estimated, possibly based on knowledge about the type of playback device, or default playback level data may be used.

The masking audio data may include background audio components included in the audio data, and the masking excitation pattern may then include a background excitation pattern, based on the background audio components and the playback level data.

The masking audio data may also include environmental sound picked up by a microphone in proximity to the listener, and the masking excitation pattern may then include an environmental excitation pattern based on the environmental sound. The environmental excitation pattern may also be based on “playback device data” that describes an impact on environmental sound by the playback device. Such playback device data may include e.g., a transfer function of an active filter of a set of hearables.

A further aspect relates to a method for audio rendering, comprising receiving an audio bitstream including target audio components and background audio components, receiving audio scene information, including a current head-pose and/or eye gaze of a listener, processing the audio scene information to obtain an audio scene state, rendering the audio data based on the scene state to obtain rendered target audio components and rendered background audio components, receiving hearing loss data associated with the listener, receiving playback level data, calculating a target excitation pattern based on the target audio components and the playback level data, calculating a masking excitation pattern based on the background audio components and the playback level data, calculating a signal gain based on the target excitation pattern, the masking excitation pattern, and the hearing loss data, and applying the signal gain to the rendered target audio components to produce compensated rendered target audio components.

Yet another aspect relates to an audio renderer comprising a decoder for receiving and decoding an audio bitstream to provide input audio including target audio components and background audio components, a scene controller configured to receive audio scene information and to provide an audio scene state based on the audio scene information, a rendering pipeline configured to render the audio data based on the scene state to obtain rendered target audio components and rendered background audio components, receive hearing loss data associated with the listener, receive playback level data, calculate a target excitation pattern based on the target audio components and the playback level data, calculate a masking excitation pattern based on the background audio components and the playback level data, calculate a signal gain based on the target excitation pattern, the masking excitation pattern, and the hearing loss data; and apply the signal gain to the rendered target audio components to produce compensated rendered target audio components.

Such audio rendering is relevant for virtual reality (augmented reality, extended reality) applications provided with an accessibility interface. For a user with a hearing impairment, calculation and application of a signal gain according to the present disclosure may be advantageous.

Such audio rendering may include receiving description data indicating whether a specific audio stream of the audio data is a target audio component or a background audio component. Such description data may be present in existing or future VR/AR/XR audio rendering devices, e.g., rendering devices complying with the MPEG-I standard.

The proposed approach enables combined optimization by leveraging one or more of:
Knowledge about the environmental sounds, for example via microphones attached to earbuds or other wearable devices;
Knowledge about the acoustical media playback level, e.g., knowing the media digital signal levels and their corresponding acoustic sound pressure level given the current volume control setting on the reproduction device;
In the case of speech intelligibility, being able to separate media speech from media background audio (if applicable);
Knowledge about the listener's hearing loss (e.g., their audiogram, or age+gender to derive a population-average audiogram);
Knowing the frequency-dependent attenuation of the acoustic environment in case the listener is wearing hearables, and in addition, what mode these hearables are operating in (e.g., passive, pass-through or acoustic noise cancellation modes) to determine the perceived environmental sound level.

Given some or all of the information above, a perceptual loudness model can predict the optimal media playback gain as a function of frequency and time to jointly optimize for the aforementioned contextual, interactive and personalization factors.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Such techniques for performing these functions may complement or replace other methods for performing similar functions.

### BRIEF DESCRIPTION OF THE DRAWINGS

For a better understanding of the various described embodiments, reference should be made to the Description below, in conjunction with the following drawings in which like descriptions refer to corresponding parts throughout the figures.

FIG. 1 illustrates spectral naturalness and timbre distortion due to hearing impairment, in accordance with some embodiments.

FIG. 2 is a schematic block diagram of a system according to an embodiment of the invention.

FIG. 3 is a more detailed block diagram of the media audio processing in FIG. 2.

FIG. 4 shows an MPEG-I audio renderer implementing an embodiment of the present invention.

FIG. 5 shows a system architecture of an MPEG-I renderer.

FIG. 6 shows processing in an MPEG-I renderer.

FIG. 7 shows rendering stages in the rendering pipeline in FIG. 6.

FIG. 8 is a flow diagram illustrating methods for improving user experience for hearing impairment, in accordance with some embodiments.

### DETAILED DESCRIPTION OF EMBODIMENTS

The following description sets forth exemplary methods, parameters, devices, and the like. It should be recognized, however, that such description is not intended as a limitation on the scope of the present disclosure but is instead provided as a description of exemplary embodiments.

There is a need for electronic devices that provide improved user experiences for hearing impaired cases. For example, there is a need for an electronic device that provides a user with audio that preserves artistic intent (e.g., loudness, timbre, spectral naturalness, externalization of spatial audio and speech intelligibility, envelopment, immersion, realism, etc.).

Although the following description uses terms “first,” “second,” etc. to describe various elements, these elements should not be limited by the terms. These terms are only used to distinguish one element from another. For example, a first data could be termed a second data, and, similarly, a second data could be termed a first data, without departing from the scope of the various described embodiments. The first data and the second data are both data, but they are not the same data.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Attention is now directed toward embodiments of the disclosed techniques which may be implemented on an electronic device. In some embodiments, the electronic device includes a memory (which optionally includes one or more computer-readable storage mediums) and one or more processing units (CPUs, GPUs, DSPs, ASICs, etc.). In some embodiments, the electronic device is of a device type frequently used to provide AR/VR content. For example, in some embodiments, the electronic device is a smartphone, tablet, or other computing system (e.g., desktop, laptop), that includes audio and video capture capability (either natively or via hardware capture devices communicatively coupled to the device).

In some embodiments, the electronic device is implemented as part of a distributed system including one or more components located in different locations. For example, in some embodiments, the electronic device includes a local hardware components and one or more remote hardware components (e.g., cloud-based components, hosted on public and/or private cloud infrastructure, SaaS, PaaS, etc.). In some embodiments, the electronic device is or includes a smartphone, tablet, or other computing system (e.g., desktop, laptop), that includes audio and video capture capability (either natively or via hardware capture devices communicatively coupled to the device).

It should be appreciated that the device described above is only one example of an electronic device, and that device optionally has more or fewer components than described, optionally combines two or more components, or optionally has a different configuration or arrangement of the components. The various components of the device described above and throughout this document are implemented in hardware, software, or a combination of both hardware and software, including one or more signal processing and/or application-specific integrated circuits.

Attention is now directed towards embodiments, implemented on, for example, an electronic device such as those described above.

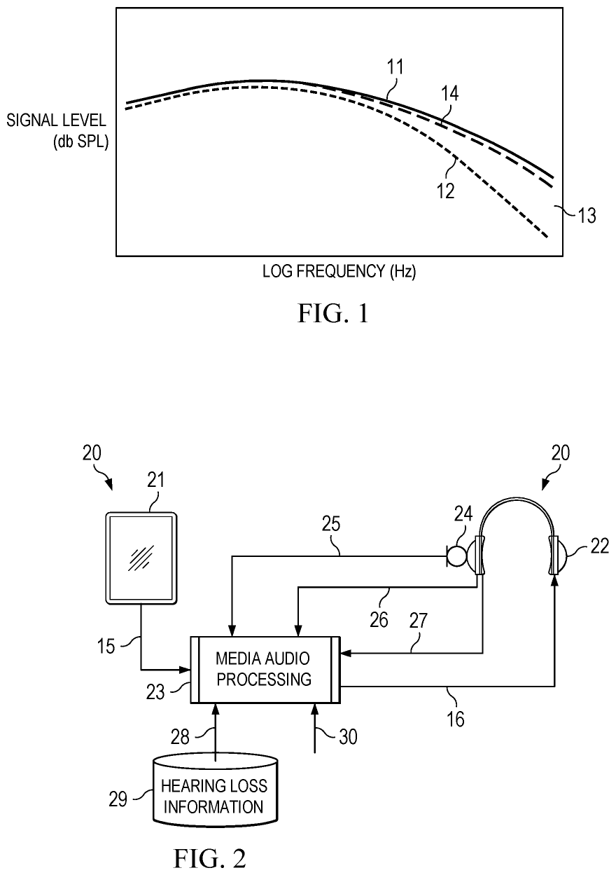

Hearing impairment is in most cases frequency and level dependent, and the loudness loss (or recruitment) is therefore also frequency and level dependent. Consequently, the spectral naturalness and timbre are distorted due to hearing impairment. FIG. 1 shows an example of an input audio signal spectrum as it is perceived by a normal-hearing listener (solid line 11) and a perceived audio signal spectrum for a listener with high-frequency hearing impairment (dotted line 12). The area 13 identifies the loss in loudness and change in perceived timbre. A hearing optimization algorithm shall aim at reducing the loudness loss and timbre change by amplifying the affected signal frequencies and creating a perceived input signal spectrum that is closer to the input signal spectrum perceived by listeners without sensorineural hearing impairment (dashed line 14).

Note that the actual signal level is not the sole factor. The frequency-dependent playback level data, which can include the playback frequency response of the hearables, also plays an important role. This playback level data allows a conversion from media digital signal levels to acoustic sound pressure levels. Therefore, if such data is available, it is encouraged to accommodate it when estimating the hearing optimized gains. Note that these gains are applied to the input signal (input audio streams) to obtain the final output signal.

Consequences of Combined Hearing Impairment and Noise Masking when Listening to Media

Hearing impairment and noise masking (both from environment and from media background) can have significant effects on how we perceive media, including:
The difficulty to understand dialog. Due to more pronounced masking of media background or environmental background sounds, elevated hearing thresholds and modified perception of loudness as a function of signal level, important details of speech may get lost or reduced, causing a reduction in dialog intelligibility.
Perceiving a distorted timbre or lack of spectral naturalness. Since both hearing loss and auditory masking are frequency and level dependent processes, the amount of information that is lost due to hearing impairment or environmental noise masking is also frequency dependent, causing the perceived timbre and spectral naturalness to degrade. For example, in low-frequency traffic noise, listeners may not be able to hear the bass of a music track, while other instruments and vocals may already be sufficiently loud. In such case, increasing the playback volume does not resolve the timbre distortion.
Loss of details of instruments or audio objects, background sounds. Quiet elements of an instrument (such as high frequency harmonics, subtle effects of string instruments, breathing sounds of vocalists, and quiet background sounds) may become inaudible or reduced in loudness due to hearing loss and noise masking.
Altered perception of dynamics and dynamic range. It is well known that hearing impairment causes the perception of dynamics, and the relation between signal level and perceived loudness to change.
Reduced spaciousness and externalization for binaural audio. Externalization and spaciousness are governed by subtle cues such as a small amount of acoustic environment simulation. With noise masking and hearing loss, these important cues can get lost or get reduced in perceived level, negatively affecting the spatial audio experience.
   Challenges when Applying Hearing-Aid Fitting Rules to Media Playback

Given the large body of work to optimize speech intelligibility in noisy environments for hearing aids, and the consequences of environmental noise and hearing loss on media consumption as outlined in the previous section, one may consider to apply hearing-aid fitting rules and algorithms to media playback in noisy environments. This, however, in practice this results in suboptimal or even poor performance for a variety of reasons. For example:
Signal components that are not considered to be in the speech frequency range are not considered important according to conventional fitting rules or hearing aid algorithms. Consequently, signal components below a couple of hundred Hertz are inadequately amplified compared to the amount of hearing loss or masking at those frequencies; a similar issue occurs at high frequencies. As a result, conventional hearing-aid fitting rules cause a significant loss of bass and treble perception in media types for which these frequency ranges are important, such as music and movies.
Optimization of speech intelligibility by equalizing the loudness of speech components causes significant distortion of the timbre and spectral naturalness of speech content, and more importantly, the timbre of content that is not speech, such as music or movies.
Conventional hearing-aid fitting rules often amplify speech components such that they are raised above an estimated environmental noise masking threshold. For noisy environments, this results in the dynamic range for processed speech becoming very small caused by aggressive processing not suitable for other media content such as music or movies.
Source separation for stereo media content, for example to separate speech from other media content, is notoriously difficult in hearing aids because hearing aids operate largely independently with very little means for across-device communication (e.g., communication between left and right hearing aids and between hearing aids and media playback devices). In a media playback use case, however, the media is strictly separated from environmental sounds, hence not requiring any source separation algorithm to separate speech from acoustic environmental sounds.
Hearing aids do not have any notion about two independent sources of masking, being signals from the environment and background sounds in the media. It is important to consider both, as both can have considerable masking effects, and/or some of these content components could be considered important and require optimization, depending on the use case.
The exact media playback level may not be known without further information on volume settings, hearable sensitivity and frequency response, and such parameters are essential for environmental noise compensation of media playback.

### General Implementation

The present disclosure proposes an integrated approach/techniques that aim at allowing listeners to hear the content as it was intended by the content creator, which implies hearing the media content as if:
there was no significant hearing loss, and/or
there was no environmental noise and/or media background masking, and/or
the playback level was close to a reference playback level, or at least providing a timbre that is close to playback at a playback reference level.

The techniques described below include a perceptual model framework for listening and optimization of media in noisy environments, and a system to optimize audio for environmental masking and hearing loss simultaneously, which improve upon the deficiencies described above with respect to existing fitting and compensation techniques (e.g., as described in the Introduction section above).

FIG. 2 illustrates a high-level system diagram in accordance with some embodiments of the proposed approach/techniques. A media playback device 20 here includes a media player 21 and a set of hearables 22 (e.g., a single transducer or pair transducers). The media player 21 may be any type of audio signal generator, such as a smartphone, a home entertainment system, a virtual reality system, etc. The hearables 22 may be a head-mounted display, a headset or a pair of earbuds worn by the listener. The hearables 22 include at last one earpiece (in the illustrated case two), each having a transducer (not shown), most typically a loudspeaker. Each earpiece may also include at least one microphone 24, configured to receive sound from the environment. In some examples, the hearables 22 may consist of a single earpiece. Also, the media playback device may be a single device including both media player 21 and hearables 22, for example a head mounted display.

The media player 21 provides an input media signal 15 that is sent to hearables 22 via a media audio processing module 23. The media player 21 may be connected to the audio processing module 23 and/or the hearables 22 by a wired or wireless connection. The media audio processing module 23 could be integrated in the media player 21 or the hearables 22, or it could be a separate entity configured to intercept the signal from the media player 21, process it, and send it on to the hearables 22. Such a separate entity could be part of a cloud processing solution. Sound captured by the hearables 22 may be communicated back to the media player 21, and/or to the media audio processing module 23.

The media audio processing module 23 is configured to receive environmental audio data 25, obtained from the one or more microphones 24 on the hearables 22, or by any other sound detecting device.

The media audio processing module 23 is further configured to receive acoustic isolation data associated with the hearables 22, alternatively referred to as playback device data 26. The playback device data 26 may include a passive part, relating to an occluding effect that the hearable 22 has on outside sound (e.g., data describing sound attenuation caused by physical occlusion of the ear canal by the hearable device). This passive part will be associated with the specific type and design of hearable 22, and may be obtained directly from the hearable (e.g., during a setup procedure). The playback device data 26 may further include an active part, related to a transfer function of an active filter in the hearable 22. Such a filter may have an attenuating or amplifying effect on sound in different frequencies. The active part of the acoustic isolation data 26 may further depend on a selected mode of the hearable 22, e.g., active noise cancelling (ANC) mode, pass-through mode. The active part may therefore be dynamic, subject to user input. The current mode of operation of the hearables 22 may be an explicit part of the playback device data 26.

The media audio processing module 23 is further configured to obtain playback level data 27 associated with the hearables 22. This data describes the (frequency dependent) conversion of the digital input signal 15 to actual sound pressure levels generated by the loudspeakers of the hearables 22. This data will depend on the specific type and design of the hearable 22, and involve the frequency characteristics of the loudspeakers in the hearables 22. In some implementations, actual playback data is received from the playback device, but if this is not possible, playback level data may be estimated, e.g., based on the type of playback device used, or a default may be assumed.

The media audio processing module 23 is further configured to obtain hearing loss data 28 describing the hearing impairment of the listener. The hearing loss data 28 may be in the form of an audiogram or a set of parameters allowing estimation of an audiogram. For example, an audiogram can be obtained from a database 29 based on demographic information about the listener (e.g., age or birth sex). Or, an audiogram may be obtained by performing a listening test or received from a hearing loss data service provider.

The media audio processing module 23 may further be configured to receive loudness adjustment data 30, e.g., a volume control user setting.

The media audio processing module 23 is configured to process the input media 15 to produce processed media 16 in response to the environmental audio data 25, acoustic isolation data/playback device data 26, playback level data 27, and hearing loss data 29. Finally, the processed media 16 is reproduced on the hearable 22.

### Embodiment Using a Perceptual Loudness Model

The general approach outlined above will now be further discussed with respect to a specific implementation based on a perceptual loudness model including modelling of the human ear as an outer and middle ear transfer function, H_{OME}, and an auditory filter transfer function, H_{ERB}.

### Calculation of Specific Loudness

The perceived loudness of sounds can be described by means of excitation and specific loudness models, e.g., as discussed in https://www.nidcd.nih.gov/health/statistics/quick-statistics-hearing. Such models typically start with the calculation of an excitation level in a set of frequency bands, from which a loudness per band is calculated. This per-band loudness is referred to as specific loudness. For simplicity and without loss of generality we will describe the process for a single frequency band, assuming that in practice, a range of spectral bands will be available that work more or less independently and have their own set of parameters.

The excitation level Eₜ for a media target input signal, Xₜ(f), represented in the frequency domain is given by:

$${E}_{t} ( {f}_{c} ) = {\int }_{0}^{∞} {‖ P ( f ) {H}_{OME} ( f ) {H}_{ERB} ( f , {f}_{c} ) {X}_{t} ( f ) ‖}^{2} df \qquad ( Eq . 1 )$$

With Hₒₘₑ(f) the outer and middle ear transfer function, H_{erb}(f,f_{c}) the auditory filter transfer function centered at frequency f_{c}, f the frequency in Hz, and P(f) representing the playback level data 27 allowing a conversion from media digital signal levels to acoustic sound pressure levels, which can include the playback frequency response of the hearable device. The playback level data P(f) required to convert digital signal levels to acoustic sound pressure levels may be dependent on various factors, such as a volume control setting of the playback device. Functions Hₒₘₑ(f) and H_{erb}(f,f_{c}) may be given by an appropriate model of the auditory system, and examples may be found in a variety of textbooks on the topic.

The specific loudness

$${N}_{t}^{′}$$

(e.g., the loudness associated with signal X(f) in the frequency band of interest) can now be computed as:

$${N}_{t}^{′} ( {f}_{c} ) = {C ( {E}_{t} ( {f}_{c} ) + A )}^{α} - {CA}^{α} \qquad ( Eq . 2 )$$

with model parameters C and A which may depend on the amount of hearing loss. Model constant α is a number between zero and one, preferably between 0.1 and 0.4, and will in the present disclosure, without any prejudice, be assumed to be 0.25.

The target input signal Xₜ(f) may be equal to the input media 15, or be a part thereof. In the latter case, some processing is required to separate the target signal from the input signal. This will be briefly discussed below.

### Loudness Model Calibration

The model parameters C and A₀ (representing 0 dB hearing loss) can be calibrated as follows. By definition, a 1 kHz tone at 40 dB SPL (40 phons) has a loudness of 1 sones for normal-hearing listeners:

$${N}^{′} = 1 = C \{ {( {H}_{OME}^{2} ( 1 kHz ) 1 {0}^{\frac{40}{10}} + {A}_{0} )}^{α} - {A}_{0}^{α} \} \qquad ( Eq . 3 )$$

$${H}_{O M E}^{2}$$

represents the squared magnitude transfer function of the outer-and-middle ear. A second datapoint for calibration is a 1 kHz tone at 2 dB SPL (2 phons) which has a loudness of 0.003 sones for normal-hearing listeners (e.g., hearing loss (HL)=0 dB). Hence for a frequency of 1 kHz we have:

$$0.003 = C \{ {( {H}_{OME}^{2} ( 1 kHz ) 1 {0}^{\frac{2}{10}} + {A}_{0} )}^{α} - {A}_{0}^{α} \} \qquad ( Eq . 4 )$$

Assuming

$${A}_{0} ≪ {H}_{OME}^{2} {10}^{\frac{40}{10}}$$

we can approximate C:

$$C \approx {( {H}_{O M E}^{2} ( 1 kHz ) 1 {0}^{\frac{40}{10}} )}^{- α} \qquad ( Eq . 5 )$$

Similarly, assuming

$${A}_{0} >> {H}_{OME}^{2} {10}^{\frac{2}{10}} ,$$

we can approximate A, via:

$$0.003 \approx C \{ {H}_{OME}^{2} ( 1 kHz ) {10}^{\frac{2}{10}} α {A}_{0}^{a - 1} \}$$

And thus:

$${A}_{0} \approx {( \frac{0.003}{{CH}_{OME}^{2} ( 1 kHz ) {α10}^{\frac{2}{10}}} )}^{\frac{1}{α - 1}} \qquad ( Eq . 6 )$$

Typical values at 1 kHz are

$${H}_{OME}^{2} = 0.79 , α = 0.25 ,$$

and hence C≈0.1, A₀≈22.8.

In order to get values for A₀ that reflect a different sensitivity across frequency, and/or due to hearing loss, we can adjust A to a different value A_{ΔT} to reflect a change in the signal level ΔT required to achieve the same loudness (0.003 sones) as a 2 phon signal:

$${A}_{Δ T} \approx {( \frac{0.003}{{CH}_{OME}^{2} ( f ) {α10}^{\frac{2 + Δ T}{10}}} )}^{\frac{1}{α - 1}} \qquad ( Eq . 7 )$$

### Calculation of Partial Specific Loudness

The loudness of a target signal with an excitation pattern Eₜ can be greatly affected by the presence of other masking signals. The loudness of the target signal within such context is referred to as partial loudness. Two types of masking signals can be discriminated, and excitation patterns can be calculated for both of these masking signal types.

The first type is the acoustic environment that the listener is in. If the acoustic environment has a signal spectrum given by Xₑ(f), the corresponding environmental sound excitation pattern Eₑ can be calculated according to:

$${E}_{e} ( {f}_{c} ) = {\int }_{0}^{∞} {‖ {H}_{hearable} ( f ) {H}_{ome} ( f ) {H}_{erb} ( f , {f}_{c} ) {X}_{e} ( f ) ‖}^{2} df \qquad ( Eq . 8 )$$

Here, H_{hearable}(f) denotes the passive or active attenuation frequency response (e.g., acoustic isolation data/playback device data 26) caused by the hearable 22 on the ear, or inside the ear canal. In case of an active frequency response caused by an active filter, this may depend on an operation mode of the hearable 22. For example, if acoustic-noise cancellation (ANC) is active, more attenuation will occur at low frequencies as a result of the ANC operation.

The second type relates to components present in the input media signal 15 that are considered to have masking contributions, for example background music and effects. If these components have a signal spectrum equal to Xₘ(f), the corresponding excitation pattern Eₘ can be calculated according to:

$${E}_{m} ( {f}_{c} ) = {\int }_{0}^{∞} {‖ P ( f ) {H}_{ome} ( f ) {H}_{erb} ( f , {f}_{c} ) {X}_{m} ( f ) ‖}^{2} df \qquad ( Eq . 9 )$$

In one embodiment, a source separation method is used to separate the media target signal Xₜ and the media background signal Xₘ from the input signal 15, for example using artificial intelligence-based algorithms.

The loudness N′_{t,m,e} of the target signal Xₜ(f) in the presence of masking signals Xₑ(f) and Xₘ(f) and their excitation patterns Eₑ and Eₘ respectively, and hearing sensitivity (or loss) adjustment ΔT is then given by:

$${N}_{t , m , e}^{′} = C \{ {( {A}_{Δ T} + ( {E}_{t} + {E}_{e} + {E}_{m} ) )}^{α} - {( {A}_{Δ T} + ( {E}_{e} + {E}_{m} ) )}^{α} \} \qquad ( Eq . 10 )$$

### Optimization

One potential optimization criterion to compensate for masking and hearing loss is to apply a time and frequency-dependent gain to the target signal Xₜ(f) such that its predicted partial specific loudness is equal to its partial specific loudness in the absence of hearing loss and masking effects. If the signal gain is denoted Gₜ(f), the partial specific loudness in context (e.g., with hearing loss and masking effects is given by):

$${N}_{t , m , e}^{′} = C \{ {( {A}_{Δ T} + ( {G}_{t}^{2} {E}_{t} + {E}_{e} + {E}_{m} ) )}^{α} - {( {A}_{Δ T} + ( {E}_{e} + {E}_{m} ) )}^{α} \} \qquad ( Eq . 11 )$$

Without context, e.g., without masking and/or hearing loss contributions, the predicted loudness is determined by eq. 2, with A=A₀:

$${N}_{t}^{′} = C \{ {( {A}_{0} + {E}_{t} )}^{α} - {( {A}_{0} )}^{α} \} \qquad ( Eq . 12 )$$

The value of Gₜ can then be calculated by requiring N′ₜ=N′_{t,m,e}:

$${G}_{t}^{2} = \frac{{\{ ( {( {E}_{t} + {A}_{0} )}^{α} - {A}_{0}^{α} ) + {( {A}_{Δ T} + {E}_{m} + {E}_{e} )}^{α} \}}^{1 / α} - {A}_{Δ T} - {E}_{m} - {E}_{e}}{{E}_{t}} \qquad ( Eq . 13 )$$

In some implementations, a user-controllable loudness adjustment factor, λ, may be included in the loudness adjustment data 30. In that case, the predicted loudness will be multiplied by factor λ:

$${N}_{t}^{′} = λ C \{ {( {A}_{0} + {E}_{t} )}^{α} - {( {A}_{0} )}^{α} \} \qquad ( Eq . 14 )$$

In this case, the value of Gₜ will become:

$${G}_{t}^{2} = \frac{{\{ λ ( {( {E}_{t} + {A}_{0} )}^{α} - {A}_{0}^{α} ) + {( {A}_{Δ T} + {E}_{m} + {E}_{e} )}^{α} \}}^{1 / α} - {A}_{Δ T} - {E}_{m} - {E}_{e}}{{E}_{t}} \qquad ( Eq . 15 )$$

It should be noted that the signal gain maybe calculated and applied in two or more frequency bands. The signal gain may further be calculated and applied in a time-varying manner.

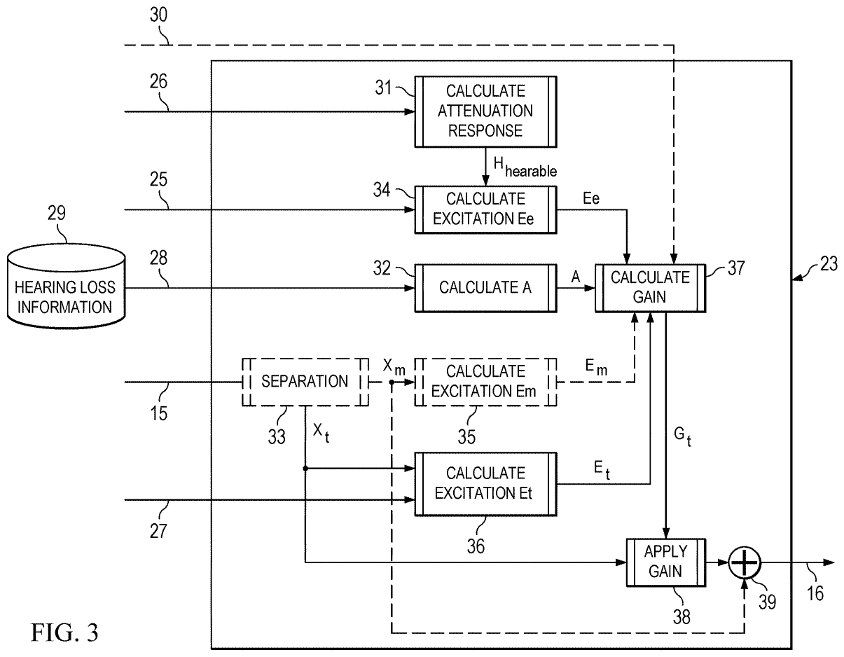

A schematic overview in block diagram form of the above approach is given in FIG. 3, showing the processing in the media audio processing module 23 in more detail. As mentioned above, the media audio processing module 23 receives acoustic isolation data/playback device data 26 (including hearable operation mode information), playback level data 27, environmental audio data 25, hearing loss data 28, optional loudness adjustment data 30, input media data 15, and produces a processed media signal 16 as output.

The playback device data 26 is received by an attenuation response calculation block 31, which determines the attenuation response H_{hearable}(f).

Hearing loss data 28 is received by a parameter calculation block 32, which calculates parameters A_{ΔT}.

In the illustrated example, the media input audio 15 is received by a source separation block 33 and is separated into a media target signal Xₜ(f) and a media background signal Xₘ(f) (if desirable). The input audio may include a set of audio components (streams or objects), in which case the media target signal includes a set of target components, and the media background signal includes a set of background components. The source separation block may be configured to perform the separation using an appropriately trained neural network, or based on characteristics of the audio components/objects, e.g., location, direction, etc. Alternatively, block 33 is connected to receive some type of description data, indicating e.g., whether a specific audio component is a target component or a background component, or whether an audio component relates to speech content or other content. In yet another implementation, information about a used head-pose and/or eye gaze may be used to distinguish between target and background audio components.

Excitation calculation blocks 34, 35, 36 receive the environment audio 25, optional media background signal Xₘ(f) and media target signal Xₜ(f), respectively, and calculate excitation patterns Eₑ, Eₘ and Eₜ, respectively. An optimization gain is computed from the various calculated excitation patterns and the optional loudness adjustment data, and applied to the media target signal. In the case a background media signal was available, that signal is mixed together with the (amplified) target signal to produce the output processed media signal.

Excitation patterns Eₑ, Eₘ and Eₜ, and the parameters A_{ΔT}, are received by a gain calculation block 37, which calculates the signal gain Gₜ according to the equation above. The gain Gₜ is applied to the target signal Xₜ(f) by gain application block 38.

In the illustrated example, where the input audio has been separated into target and background, the background signal Xₘ(f) is added back to the gain-adjusted target signal in summation point 39, in order to provide the final output audio 16.

### Envisioned Use Cases

### Hearing Loss Compensation in Quiet

In this use case, the goal is to apply compensation for hearing loss assuming the listener is in a relatively quiet environment. One example could be a listener listening to music or a podcast, reproduced in a personalized way by taking the listener's hearing loss into account. The masking effect of environmental audio is assumed to be small, or could be disabled completely to reduce processing power and hence improve battery life in case some of the processing runs on a battery-powered device. The processing device may provide means for the listener to input loudness adjustment data, such that the perceived loudness can be adjusted in a more natural way than simply adjusting the media playback level.

### Personalized Media Optimization in Noisy Environments

In noisy environments, media reproduction can be improved and personalized by compensating for the listener's hearing loss and the masking effects of the acoustic environment. Assuming the listener is wearing hearables, for example with a headphones or earbud formfactor, the resulting acoustic isolation or attenuation from the device (e.g., acoustic isolation data) is taken into account in the optimization process. Moreover, if the hearable has so-called ANC or pass-through modes, the acoustic attenuation response is adjusted accordingly to represent the combined effect of putting a device in or around the ear, and its effect on passing environment audio through into the ear canal. Lastly, the user may adjust playback loudness by means of inputting loudness adjustment data.

### Personalized, Context-Aware Dialog Enhancement

Dialog present in media content can be buried in media background sounds and/or partially masked by environmental audio. To overcome this problem, the proposed solution separates dialog (the media target audio signal) from the background (the media background audio). Subsequently, the media target audio signal is optimized to compensate for one or more factors of (1) the listener's hearing loss, (2) the masking effect of the media background audio, and (3) the environmental audio (if any). If hearing loss taken into account, the dialog enhancement feature therefore becomes personalized and context aware.

### Personalized, Context Aware Augmented Reality

One of the challenges of augmented reality is loudness management; the perceived loudness of virtual (augmented) content needs to be sufficiently high to be audible in noisy environments, but not too high to be uncomfortable. By associating the augmented reality signals as the target signal, and taking environmental audio and hearing loss into account, the loudness of augmented reality components can be managed fully automatically without needing user interaction.

### Directional, Interactive, Personalized, Context-Aware Object Enhancement

In some use cases it is desirable to improve the audibility of audio components with an intended direction or position that is in the field of view of the listener. In such use cases, the separation of target media target and background signals can be applied by determining if the target media signal is in the field of view or not. One embodiment of such a process would be to use object-based audio coordinates in combination with head tracking to determine which objects are in the field of view. The field-of-view signal components are then optimized based on the assumption that all objects outside the field of view are considered background audio components. Head tracking of the listener allows the listener to direct which objects need to be optimized simply by looking towards them. Hence this enhancement is directional, interactive, context-aware and personalized.

In some use cases, and in contrast to the previous example, objects outside the field of view may be enhanced such that they become clearly audible when masking due to background media and/or environmental audio is occurring. Such enhancement is especially relevant for warning signals occurring outside the field of view.

### Implementation in VR Applications

A particular use case relates to VR (AR, XR, etc) applications, where audio is rendered using head tracking data in order to simulate an effect of moving in an audio landscape. Such applications are sometimes provided with an “accessibility user interface” allowing the user to provide input intended to eliminate or at least reduce an effect of various impairments, e.g. hear impairment.

An Accessibility User Interface may provide acoustic scene adjustment such as adjustment of early reflection, reverb and distance acoustic effects, and directional focus effect that is intended to attenuate distracting sounds from directions outside of a spatial region of interest. All these effects are generated responding to the user 6DoF (Six degree-of-freedom) pose and/or eye gaze in the VR/AR/XR world.

A drawback with this approach is that the user has to selectively tune each of the effects independently to achieve the desired overall effect. A certain degree of knowledge on acoustic effects may also be required to properly adjust the parameters related to a particular effect. This could be undesirable for most hearing-impaired users. By implementing techniques discussed above, it is possible to improve user experience for all users, with or without a proper hearing loss diagnosis.

Hearing optimized gains (e.g. G, as discussed above) can be estimated based on, e.g., an audiogram, signal level information and playback level information. In Virtual Reality applications, the acoustic effects such as distance attenuation, occlusion, early reflections, reverberation and diffraction are introduced to the input signal as the user explores the virtual space with 6 degree-of-freedom (6DoF) movement. This may influence the overall signal level.

The foreground/target signal content (Xₜ) may be defined as the original input signal content or the combined input content and the resulting acoustic effects. In some cases, it may be necessary to keep the input signal content as the foreground/target signal but with reduced acoustic effects to improve intelligibility. Alternatively, the acoustic effects themselves can be categorized as the background signal.

A background signal (Xₘ) such as background music may also be provided as an input audio stream as part of the content creator intent. Several foreground/target and background signals may be specified. Classifying an audio stream as a foreground or background signal can potentially improve the calculation of hearing optimized gains. Depending on the signal levels of both the background and target signals, the gains are adjusted with the aim to ensure that the target signal is audible for hearing impaired people in the presence of the background.

Alternatively, an audio stream may already be the foreground/target signal itself mixed with the background signal. In Augmented Reality applications, this may be an audio signal coming from a real sound source mixed with the background noise or environment. In this case, a source separation or denoising may need to be performed beforehand. An additional audio stream containing the extracted background noise may be added as input to an audio renderer, for example, the MPEG-I Audio renderer. This stream may have the same pose as its mixed audio stream. In some cases, it may be necessary to provide the “denoised” audio stream itself or if the “denoising” filter coefficients, e.g., frequency-domain Wiener filtering, are provided, the renderer may perform the denoising operation.

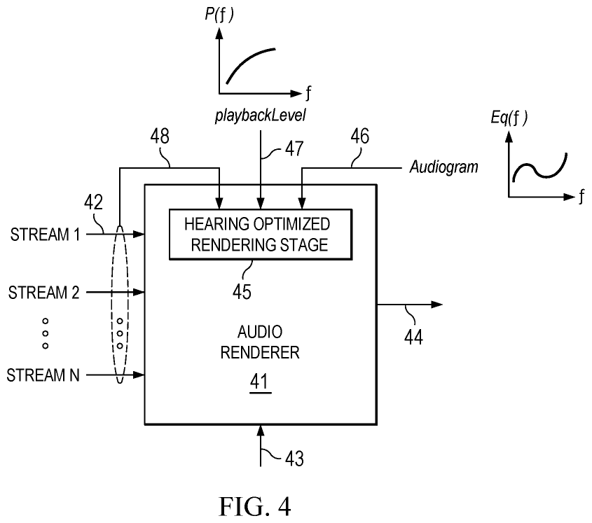

FIG. 4 shows an audio renderer 41 (such as an MPEG-I audio renderer) taking a set of audio streams 42 and a 6 DoF head pose and/or eye gaze 43 as input and providing a rendered audio 44 as output. The audio renderer 41 is here provided with a hearing optimized rendering stage 45, which takes an audiogram 46, and playback level, P(f), 47 as input in order to apply a signal gain in accordance with the present disclosure. The hearing optimized rendering stage could e.g., implement a media audio processing module 23 as shown in FIG. 3.

Based on the above examples, the following parameters may be useful in a system implementing the techniques disclosed herein (e.g., MPEG-I Audio Renderer):

| | |
|---|---|
| playbackLevel | A scalar or an array of frequency-dependent absolute playback |
| | level, P(f) in dB SPL (e.g., default: 70 dB SPL) or relative |
| | playback level in dB (e.g., default: 90 dB). This was labelled 27 |
| | in FIG. 3. |
| audiogram | An array of frequency-dependent hearing loss level in dB (e.g., |
| | default: derived from demographic data such as age and gender). |
| | This was labelled 28 in FIG. 3. |
| targetSignal | A Flag to indicate if an audio stream is considered as a |
| | foreground/target [true] or background signal [false] (e.g., |
| | default: true). This would be used as description data in block 33 |
| | in FIG. 3. |

Note that the playbackLevel, P(f), could come from the playback device (such as the current volume setting combined with sensitivity information such as frequency response of the headphones), or from a separate bit stream (e.g. an MPEG-I bit stream) if provided as such as a suggested or required playback level. If no playback level data is available, the system may use common or appropriate default playback level data. For example, the system may assume that a digital signal level with linear amplitude of 1.0 re digital full scale corresponds to 90 dB SPL in the acoustical domain.

An interesting aspect of applying the present disclosure to a renderer (e.g., audio renderer 41) having access to the individual audio sources/streams 42, is that this allows a content creator to classify certain audio sources as, e.g., the foreground or background sources. This can be done, e.g., by utilizing a parameter that indicates that a respective audio source should be prioritized (e.g., not be subject to “culling”).

For example, in future versions of MPEG-I it is expected that a “noCulling” parameter attached to each audio stream will be specified as one of the MPEG-I parameters. If it is set to “1” or “true”, it indicates that the audio stream shall never be culled, which may be used to specify the targetSignal flag. Setting the parameter to “1” may be interpreted as an indication that the audio stream is the foreground or target signal.

In the absence of information identifying audio streams as “target” or “background”, a separation of input audio into these types of audio may be performed based on the current head-pose and/or eye gaze. For example, if the user looks in a certain direction, this is likely where his/her focus is, and audio from this direction is likely “target” audio.

Future versions of MPEG-I are also expected to include a loudness user interface as an interface for the application of loudness-based audio culling. The aim is to allow for existing MPEG-D/H loudness metadata to be delivered to MPEG-I renderer to perform audio culling based on the absolute and relative loudness criteria. Such loudness information may be specified by the content creator. It may be taken as an additional input to the rendering stage, labelled 48 in FIG. 4.

In addition to that, an additional processing block (e.g., a “hearing optimized rendering stage”) is provided within a system implementing the techniques disclosed herein. For example, an MPEG-I implementation as illustrated in FIG. 4, includes a processing block to enable optimized rendering. This rendering stage is responsible for the frame-wise real-time adjustment of the time-frequency dependent hearing optimized gains based on the input parameters described above.

Future versions of MPEG-I are expected to include spectral compensation of any user specified “Accessibility Equalization”. Such spectral compensation would aim to synthesize user specified filters (in the renderer framework local configuration parameters) and subsequently perform a filtering on the binauralized audio output within the “binaural spatializer” stage. It could process both the diotic and dichotic spectral compensation. Such processing would provide an opportunity to implement the hearing optimized rendering stage 45.

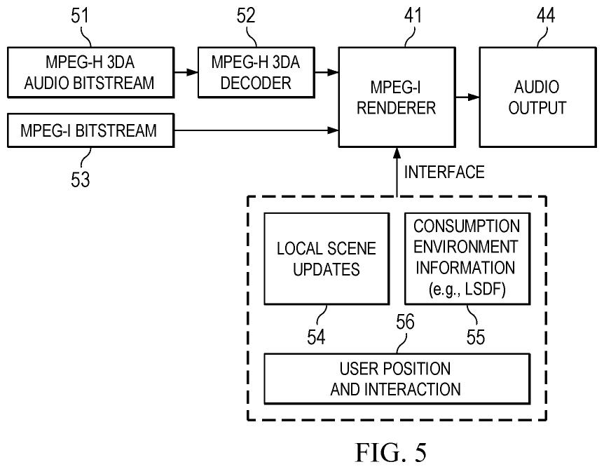

FIG. 5 shows an overview of a rendering process including an example of the audio renderer 41, here implemented as an MPEG-I renderer. An MPEG-I renderer 41 typically operates with a global sampling frequency of 48 kHz. FIG. 5 illustrates how the renderer 41 in this example is connected to an MPEG-H 3DA coded Audio Element bitstream 51 via an MPEG-H 3DA decoder 52.

All audio elements (e.g., channels, objects, HOA) that are input into the renderer have a counterpart in the MPEG-I Immersive audio standard, namely so-called source type:
Objects sources are provided with VR/AR specific properties
Channels sources are played back in the virtual world through a virtual loudspeaker setup
HOA sources can be rendered into the virtual world in two different ways: either individually with three degrees of freedom (user orientation) or in a group with six degrees of freedom
   For all three paradigms, encoded waveforms can be carried over from MPEG-H 3D audio to MPEG-I Immersive audio directly without the need for any re-encoding and associated loss in quality.

The decoded audio is rendered together with an MPEG-I bitstream 53. The MPEG-I bitstream 53 carries the audio scene description and other metadata used by the renderer 41. The renderer 41 also has interfaces to access consumption environment information (e.g. LSDF) 54, scene updates during playback 55, and user position and interactions information 56. The inputs 54, 55 and 56 may be referred to as audio scene information.

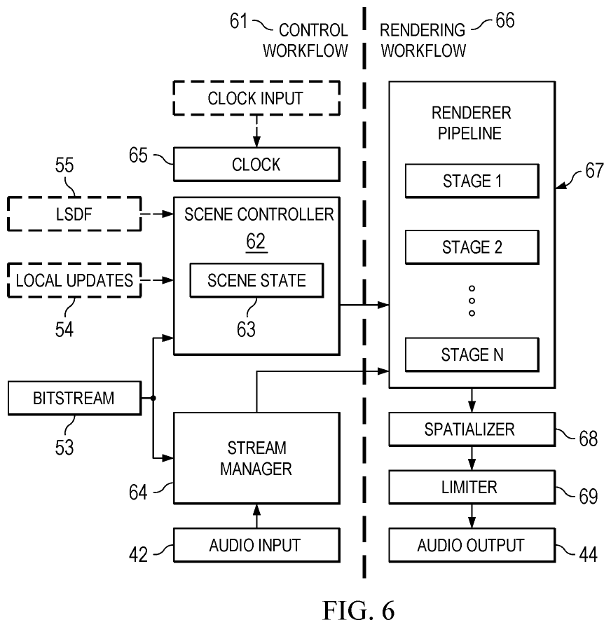

The renderer 41 allows real-time auralization of complex 6DoF audio scenes where the user may directly interact with entities in the scene. To achieve this, the multithreaded software architecture is divided into several workflows and components. A block diagram with all renderer components is shown in FIG. 6. The renderer 41 supports the rendering of VR as well as AR scenes. In the case of VR and AR scenes, the rendering metadata and the audio scene information is obtained from the bitstream 53. In the case of AR scenes, the listening space information is obtained as LSDF (Listener Space Description Format) file 55 during playback. The components in the diagram are briefly described in the following.

The control workflow 61 is the entry point of the renderer 41 and is responsible for the interfaces with external systems and components. Its main functionality is embedded in the scene controller component 62, which coordinates the state of all entities in the 6DoF scene and implements the interactive interfaces of the renderer 41. The scene controller 62 supports external updates of modifiable properties of scene objects, as well as reading and parsing the LSDF files 55 to complete the information in the bitstream. The scene controller 62 also keeps track of time- or location-dependent properties of scene objects (e.g. interpolated locations or listener proximity conditions).

The scene state 63 always reflects the current state of all scene objects, including audio elements, transforms/anchors and geometry. Other components of the Renderer can subscribe to changes in the scene state 63. Before rendering starts, all objects in the entire scene are created and their metadata is updated to the state that reflects the desired scene configuration at start of playback.

The stream manager 64 provides a unified interface for renderer components to access audio streams 42 associated with an audio element in the scene state 63. Audio streams 42 are input to the render 41 as (decoded) PCM float samples. The source of an audio stream 42 may for example be decoded MPEG-H audio streams 51 or locally captured audio.

The clock 65 provides an interface for renderer components to get the current scene time in seconds. The Clock input may for example be a synchronization signal from other subsystems or the internal wall clock of the renderer. The Clock input to the Scene is not related to audio synchronization.

The rendering workflow 66 is producing PCM float audio output signals 44. It is separated from the control workflow 61 and only the scene state 63 (for communicating any changes in the 6DoF scene) and the stream manager 64 (for providing input audio streams) are accessible from the rendering workflow 66 for communication between both workflows.

The renderer pipeline 67 auralizes the input audio streams 42 provided by the stream manager based on the current scene state. The rendering is organized in a sequential pipeline, such that individual rendering stages implement independent perceptual effects and make use of the processing of preceding and subsequent stages.

The spatializer 68 terminates the renderer pipeline 67 and auralizes the output of the renderer stages to a single output audio stream suitable for the desired playback method (e.g. binaural or adaptive loudspeaker rendering). Finally, the limiter 69 provides clipping protection for the auralized output signal.

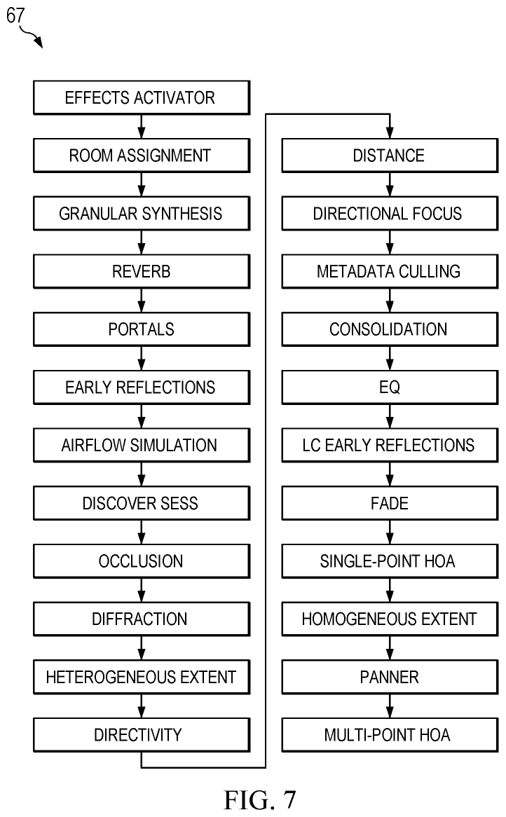

FIG. 7 illustrates the renderer pipeline 67 where each box represents a separate rendering stage. The rendering stages are instantiated during renderer initialization. rendering stages are computed in the sequence presented in the figure.

Since the hearing optimized rendering stage 45 (see FIG. 4) benefits from knowledge of individual source classification (e.g. from the noCulling flag), the hearing optimized rendering stage 45 may be implemented within the renderer pipeline 67, just before the (binaural or loudspeaker) spatializer 68. For example, at the end of the renderer pipeline after the MP-HOA rendering stage in FIG. 7. Note that, at this stage, all 6DoF acoustic effects (occlusion, diffraction, reflections, reverb, etc.) in the VR/AR/XR applications are available in the form of render items to be fed into the spatializer 68.

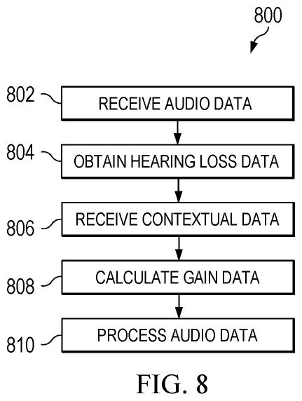

FIG. 8 is a flow diagram illustrating a method for optimizing user experience under hearing impairment on an electronic device, in accordance with some embodiments. Method 300 is performed at an electronic device (e.g., an electronic device as described herein).

The electronic device receives (e.g., 302) audio data. In some embodiments, audio data includes one or more audio streams. In some embodiments, audio data includes loudness data. The electronic device obtains (e.g., 304) hearing loss data associated with a listener. In some embodiments, hearing loss data is audiogram data associated with the listener. In some embodiments, audiogram data is derived from a hearing test associated with the listener. In some embodiments, audiogram data is derived from demographic information associated with the listener.

The electronic device receives (e.g., 306) contextual data including playback level data and calculates (e.g., 308) gain data (e.g., time-frequency dependent hearing optimized gains) based the audio data, the hearing loss data, and the contextual data. In some embodiments, the playback level data is a scalar or an array of frequency-dependent absolute playback level in dB SPL. In some embodiments, a relative playback level in dB).

The electronic device processes (e.g., 310) at least a portion of the audio data with the gain data to produce compensated audio data.

In some embodiments, the contextual data includes signal description data. In some embodiments, the signal description data indicates whether respective audio data corresponds to a foreground or background signal. In some embodiments, the signal description data indicates whether a foreground signal is a speech signal or a non-speech signal.

In some embodiments including signal description data, the electronic device determines a value associated with the signal description data is either a first value or a second value (e.g., True or False), and in accordance with a determination that the value associated with the signal description data is a first value (e.g., True), the gain data is a first set of gain data, and in accordance with a determination that the value associated with the signal description data is a second value (e.g., False), the gain is a second set of gain data different than the first set of gain data.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Various aspects and implementations of the present disclosure may also be appreciated from the following enumerated example embodiments (EEEs), which are not claims.

EEE1. A method of processing audio for a listener of a playback device, comprising:
receiving audio data;
receiving hearing loss data associated with the listener;
receiving contextual data including one or more of: environmental sound data, acoustic isolation data, and playback level data; and
calculating an audio level data based on at least a portion of the audio data;
calculating gain data based on the audio level data and the contextual data; and
processing at least a portion of the audio data with the gain data to produce compensated audio data.
   EEE2. The method of EEE1, wherein the audio data includes background components and target components; and wherein processing at least a part of the audio signal includes processing the target components with the gain data and forgoing processing of the background components with the gain data.
   EEE3. The method of EEE2, further comprising:
prior to receiving the audio data, determining target components of the audio data based at least in part on a direction or a position of one or more objects or sources represented in the audio data.
   EEE4. The method of any of EEE1-EEE3, further comprising:
calculating one or more perceptual excitation levels; and
wherein calculating an audio level data is based in part on at least one of the one or more perceptual excitation levels.
   EEE5. The method of EEE4, wherein calculating the one or more perceptual excitation levels includes calculating an excitation loss function based on the hearing loss data.
   EEE6. The method of any of EEE4-EEE5, wherein the contextual data includes environmental sound data and wherein calculating the one or more perceptual excitation levels includes calculating an excitation level associated with the environmental sound data.
   EEE7. The method of any of EEE4-EEE6, wherein the contextual data includes acoustic isolation data, and wherein the calculating excitation level associated with the environmental sound data is based in part on the acoustic isolation data.
   EEE6. The method of any of EEE4-7, when depending from EEE2, wherein calculating the one or more perceptual excitation levels includes:
calculating an excitation level associated with the background components of the of the audio data; and
calculating an excitation level associated with the target components of the audio data.
   EEE7. The method of EEE6, when depending from EEE5, wherein calculating the one or more perceptual excitation levels further comprises:
applying the excitation loss function to the excitation level associated with the background components; and
applying the excitation loss function to the excitation level associated with the target components of the audio data.
   EEE8. The method of any of the previous EEEs, further comprising:
receiving loudness adjustment data; and
updating the gain based on the loudness adjustment data.
   EEE9. The method of any of the previous EEEs, wherein the gain data is calculated and applied in two or more frequency bands.
   EEE10. The method of any of the previous EEEs, wherein the gain data is calculated and applied in a time-varying manner.
   EEE11. The method of any of the previous EEEs, wherein calculating the gain data includes involves optimizing a perceptual loudness constraint.
   EEE12. The method of any of the previous EEEs, wherein the contextual data includes environmental sound data; and wherein the environmental sound data is derived from one or more microphones on a device in proximity to the listener.
   EEE13. The method of any of the previous EEEs, wherein hearing loss data is derived from an age or birth sex of the listener.
   EEE14. The method of any of the previous EEEs, wherein input loudness adjustment data is received at the playback device via user input from the listener.
   EEE15. The method of any of the previous EEEs, wherein the playback device is a hearable device; and
one or more of calculating audio level data, calculating gain data, and processing the audio data with the gain data is performed on the hearable device.
   EEE16. The method of any of the previous EEEs, wherein the contextual data includes environmental sound data; and wherein the environmental audio data is captured from one or more microphones of a hearable device in communication with a mobile device.
   EEE17. A non-transitory computer-readable storage medium storing instructions which, when executed by a computing apparatus, cause the computing apparatus to perform the method of any of EEE1-EEE16.
   EEE18. A computing apparatus, comprising:
at least one processor; and
memory storing instructions, which when executed by the at least one processor, cause the computing apparatus to perform the method of any of EEE1-EEE16.
   EEE19. A method of processing audio, comprising:
receiving audio data;
obtaining hearing loss data associated with a listener;
receiving contextual data including playback level data;
calculating gain data based the audio data, the hearing loss data, and the contextual data; and
processing at least a portion of the audio data with the gain data to produce compensated audio data.
   EEE20. The method of EEE19, wherein the contextual data includes signal description data, and the method further comprises:
determining a value associated with the signal description data is either a first value or a second value, and
in accordance with a determination that the value associated with the signal description data is a first value, the gain data is a first set of gain data; and
in accordance with a determination that the value associated with the signal description data is a second value, the gain is a second set of gain data different than the first set of gain data.
   EEE21. A non-transitory computer-readable storage medium storing instructions which, when executed by a computing apparatus, cause the computing apparatus to perform the method of any of EEE19 or EEE20.
   EEE22. A computing apparatus, comprising:
at least one processor; and
memory storing instructions, which when executed by the at least one processor, cause the computing apparatus to perform the method of any of EEE19 or EEE20.

1. A method of processing audio for a listener of a playback device, comprising:
receiving audio data for playback on the playback device, the audio data including target audio components;
receiving masking audio data;
obtaining hearing loss data associated with the listener;
obtaining playback level data;
calculating a target excitation pattern based on the target audio components and the playback level data;
calculating a masking excitation pattern based on the masking audio data;
calculating a signal gain based on the target excitation pattern, the masking excitation pattern, and the hearing loss data; and
applying the signal gain to the target audio components to produce compensated target audio components.

2. The method of claim 1, wherein the masking audio data includes background audio components included in the audio data, and wherein the masking excitation pattern includes a background excitation pattern, based on the background audio components and the playback level data.

3. The method of claim 2, further comprising receiving description data indicating whether a specific audio stream of the audio data is a target audio component or a background audio component.

4. The method of claim 2, further comprising separating the audio data into the target audio components and the background audio components.

5. The method of claim 4, wherein the step of separating the audio data into the target audio components and the background audio components involves determining the target audio components of the audio data based on a direction or a position of one or more audio objects or audio sources represented in the audio data.

6. The method of claim 1, wherein the masking audio data includes environmental sound captured by a microphone in proximity to the listener, and wherein the masking excitation pattern includes an environmental excitation pattern based on the environmental sound.

7. The method of claim 6, wherein the playback device includes a set of hearables, and the environmental sound is captured from a microphone of the hearables.

8. The method of claim 6, further comprising:
receiving playback device data that describes an impact on environmental sound by the playback device, and wherein the environmental excitation pattern is based also on the playback device data.

9. The method of claim 8, wherein the playback device includes a set of hearables with at least one earpiece, each earpiece including a microphone, a loudspeaker and an active filter, wherein the playback device data includes a transfer function of the active filter.

10. The method of claim 1, wherein the signal gain is calculated and applied in two or more frequency bands.

11. The method of claim 1, wherein the signal gain is calculated and applied in a time-varying manner.

12. The method of claim 1, wherein calculating the signal gain includes:
calculating a predicted specific loudness of the target excitation pattern without masking and without hearing loss,
calculating a partial specific loudness of the target excitation pattern masked by the masking excitation pattern and based on the hearing loss data,
determining the signal gain as a gain of the target audio components which results in a predicted specific loudness approximately equal to the partial specific loudness.

13. The method of claim 12, wherein the signal gain is calculated as predicted specific loudness is calculated as:
$${G}_{t}^{2} = \frac{{\{ ( {( {E}_{t} + {A}_{0} )}^{α} - {A}_{0}^{α} ) + {( {A}_{Δ T} + {E}_{m} + {E}_{e} )}^{α} \}}^{1 / α} - {A}_{Δ T} - {E}_{m} - {E}_{e}}{{E}_{t}}$$
where Eₜ is the target excitation pattern, Eₘ is the background excitation pattern, Eₑ is the environmental excitation pattern, A₀ is a model parameter representing 0 dB hearing loss, A_{ΔT} is a hearing loss dependent model parameter, and α is a constant between 0.1 and 0.4.

14. The method of claim 1, further comprising:
receiving a loudness adjustment factor; and
calculating signal gain also based on the loudness adjustment factor.

15. The method of claim 14, wherein the loudness adjustment factor is received at the playback device via user input from the listener.

16. The method of claim 14, wherein the signal gain is calculated as predicted specific loudness is calculated as:
$${G}_{t}^{2} = \frac{{\{ λ ( {( {E}_{t} + {A}_{0} )}^{α} - {A}_{0}^{α} ) + {( {A}_{Δ T} + {E}_{m} + {E}_{e} )}^{α} \}}^{1 / α} - {A}_{Δ T} - {E}_{m} - {E}_{e}}{{E}_{t}}$$
where λ is the loudness adjustment factor, Eₜ is the target excitation pattern, Eₘ is the background excitation pattern, Eₑ is the environmental excitation pattern, A₀ is a model parameter representing 0 dB hearing loss, A_{ΔT} is a hearing loss dependent model parameter, and a is a constant between 0.1 and 0.4.

17. The method of claim 1, wherein hearing loss data is derived from an age or birth sex of the listener.

18. The method of claim 1, wherein the playback device includes a set of hearables; and
wherein one or more of calculating signal gain and applying the signal gain is performed on the hearables.

19. (canceled)

20. (canceled)

21. (canceled)

22. A non-transitory computer-readable storage medium storing instructions which, when executed by a computing apparatus, cause the computing apparatus to;
receive audio data for playback on a playback device, the audio data including target audio components;
receive masking audio data;
obtain hearing loss data associated with a listener of the playback device;
obtain playback level data;
calculate a target excitation pattern based on the target audio components and the playback level data;
calculate a masking excitation pattern based on the masking audio data;
calculate a signal gain based on the target excitation pattern, the masking excitation pattern, and the hearing loss data; and
apply the signal gain to the target audio components to produce compensated target audio components.

23. A computing apparatus, comprising:
at least one processor; and
memory storing instructions, which when executed by the at least one processor, cause the computing apparatus to;
receive audio data for playback on a playback device, the audio data including target audio components;
receive masking audio data;
obtain hearing loss data associated with a listener of the playback device;
obtain playback level data;
calculate a target excitation pattern based on the target audio components and the playback level data;
calculate a masking excitation pattern based on the masking audio data;
calculate a signal gain based on the target excitation pattern, the masking excitation pattern, and the hearing loss data; and
apply the signal gain to the target audio components to produce compensated target audio components.

24. (canceled)

25. (canceled)

26. (canceled)
